(19) United States
(12) Patent Application Publication
(10) Pub. No.: US 2025/0371043 A1
(43) Pub. Date: Dec. 4, 2025

(54) Task-Specific Prompt Recycling for Machine-Learned Models that Perform Multiple Tasks

(71) Applicant: Google LLC, Mountain View, CA (US)

(72) Inventors: Joshua Franko Yurtsever, San Francisco, CA (US); Siamak Shakeri, New York, NY (US); Noah J.G. Constant, Los Angeles, CA (US); Brian David Lester, Detroit, MI (US)

(21) Appl. No.: 19/151,590

(22) PCT Filed: Jul. 19, 2023
(86) PCT No.: PCT/US2023/028162

§ 371 Date: Jul. 28, 2025

Related U.S. Application Data
(60) Provisional application No. 63/390,542, filed on Jul. 19, 2022.

(51) Int. Cl. G06F 16/332; G06N 20/00

(52) U.S. Cl. CPC G06F 16/3325; G06N 20/00

(57) ABSTRACT

Systems and methods of the present disclosure are directed to a computer-implemented method for recycling of task-specific prompts for machine-learned models. The method includes obtaining a task-specific prompt for a first machine-learned model, wherein the task-specific prompt is indicative of a task of a plurality of tasks the first machine-learned model is configured to perform. includes determining a difference between the first machine-learned model and a second machine-learned model different than the first machine-learned model. The method includes, based at least in part on the difference, modifying the task-specific prompt to obtain an updated task-specific prompt that corresponds to the second machine-learned model.

### PRIORITY CLAIM

The present application is based on and claims priority to U.S. Provisional Patent Application 63/390,542 having a filing date of Jul. 19, 2022, which is incorporated by reference herein.

### FIELD

The present disclosure relates generally to machine-learned models that can perform multiple tasks. More particularly, the present disclosure relates to prompt recycling for machine-learned multitasking models after model updates.

### BACKGROUND

Large machine-learned language models (LLMs) have recently been utilized to perform multiple tasks. Generally, the parameters of an LLM are frozen, and then task-specific soft prompts that modulate the behavior of the LLM are concatenated with model inputs to prompt the LLM to perform various tasks. However, task-specific soft prompts are generally coupled to the frozen LLM, and any updates to parameters of the LLM necessitate the creation of new prompts.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for recycling task-specific prompts for machine-learned models. The method includes obtaining, by a computing system comprising one or more computing devices, a task-specific prompt for a machine-learned model, wherein the task-specific prompt is indicative of a task of a plurality of tasks the machine-learned model is configured to perform. The method includes determining, by the computing system, a difference between a base version of the machine-learned model and an updated version of the machine-learned model different than the base version of the machine-learned model. The method includes, based at least in part on the difference, modifying, by the computing system, the task-specific prompt to obtain an updated task-specific prompt that corresponds to the updated version of the machine-learned model.

Another example aspect of the present disclosure is directed to a computing system for recycling of task-specific prompts for machine-learned models. The computing system includes one or more processors. The computing system includes one or more non-transitory computer-readable media that store instructions that, when executed by the one or more processors, cause the computing system to perform operations. The operations include obtaining a task-specific prompt for a first machine-learned model, wherein the task-specific prompt is indicative of a task of a plurality of tasks the first machine-learned model is configured to perform. The operations include determining a difference between the first machine-learned model and a second machine-learned model different than the first machine-learned model. The operations include, based at least in part on the difference, modifying the task-specific prompt to obtain an updated task-specific prompt that corresponds to the second machine-learned model.

Another example aspect of the present disclosure is directed to one or more non-transitory computer-readable media that store instructions that, when executed by one or more processors, cause the one or more processors to perform operations. The operations include obtaining a task-specific prompt for a first machine-learned model, wherein the task-specific prompt is indicative of a task of a plurality of tasks the first machine-learned model is configured to perform. The operations include determining a difference between a base version of the machine-learned model and a second machine-learned model different than the first machine-learned model. The operations include, based at least in part on the difference, modifying the task-specific prompt to obtain an updated task-specific prompt that corresponds to the second machine-learned model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs task-specific prompt recycling according to example embodiments of the present disclosure.

FIG. 1B depicts a block diagram of an example computing device that performs task-specific prompt recycling according to example embodiments of the present disclosure.

FIG. 1C depicts a block diagram of an example computing device that performs task-specific prompt recycling according to example embodiments of the present disclosure.

FIG. 2 depicts a block diagram of an example computing system for recycling of task-specific prompts according to example embodiments of the present disclosure.

FIG. 3 depicts a flow chart diagram of an example method to perform task-specific prompt recycling according to example embodiments of the present disclosure.

FIG. 4 illustrates an example data flow diagram for recycling of task-specific prompts between a source model and target model according to example embodiments of the present disclosure.

Reference numerals that are repeated across plural figures are intended to identify the same features in various implementations.

### DETAILED DESCRIPTION

### Overview

Generally, the present disclosure is directed to task-specific prompt recycling. Specifically, task-specific prompts are used for machine-learned models that can perform multiple tasks. For example, the parameters of a large machine-learned language model (LLM), can be frozen and utilized to perform multiple language tasks. To prompt a LLM to perform a particular task, a task-specific prompt can be concatenated to an input to the LLM. The task-specific prompt indicates a task of a number of tasks that the LLM can perform. At inference, the LLM will process the input in accordance with the task specified by the task-specific prompt. However, these task-specific prompts are often closely coupled to the state of the LLM (e.g., the values of the parameters of the LLM, etc.). As such, if the LLM is updated, the task-specific prompts will no longer correctly prompt the LLM to perform certain tasks.

Accordingly, implementations of the present disclosure propose systems and methods for computer-implemented method for recycling of task-specific prompts for machine-learned models. For example, a computing system can obtain a task-specific prompt for a first machine-learned model (e.g., a LLM with frozen parameters, etc.). The task-specific prompt can indicate a task of a plurality of tasks the first machine-learned model is configured to perform. The computing system can determine a difference between the first machine-learned model and a second machine-learned model different than the first machine-learned model. For example, the first and second machine-learned models may respectively be base and updated versions of the same machine-learned model. Based at least in part on the difference, the computing system recycles the task-specific prompt by modifying the task-specific prompt to obtain an updated task-specific prompt that corresponds to the second machine-learned model (i.e., a recycled task-specific prompt). This updated task-specific prompt can be concatenated to inputs to the second machine-learned model to correctly indicate tasks.

Implementations of the present disclosure provide a number of technical effects and benefits. As an example, the generation of task-specific prompts generally requires machine-learned processing, and can incur a substantial cost in computing resources. Conventionally, updating a machine-learned model, such as an LLM, necessitates that all task-specific prompts must be re-created for the updated version of the LLM. However, by providing the capability to recycle task-specific prompts, implementations of the present disclosure substantially reduce the compute resources required to utilize task-specific prompts with updated machine-learned models (e.g., memory, storage, power, compute cycles, etc.).

With reference now to the Figures, example embodiments of the present disclosure will be discussed in further detail.

### Example Devices and Systems

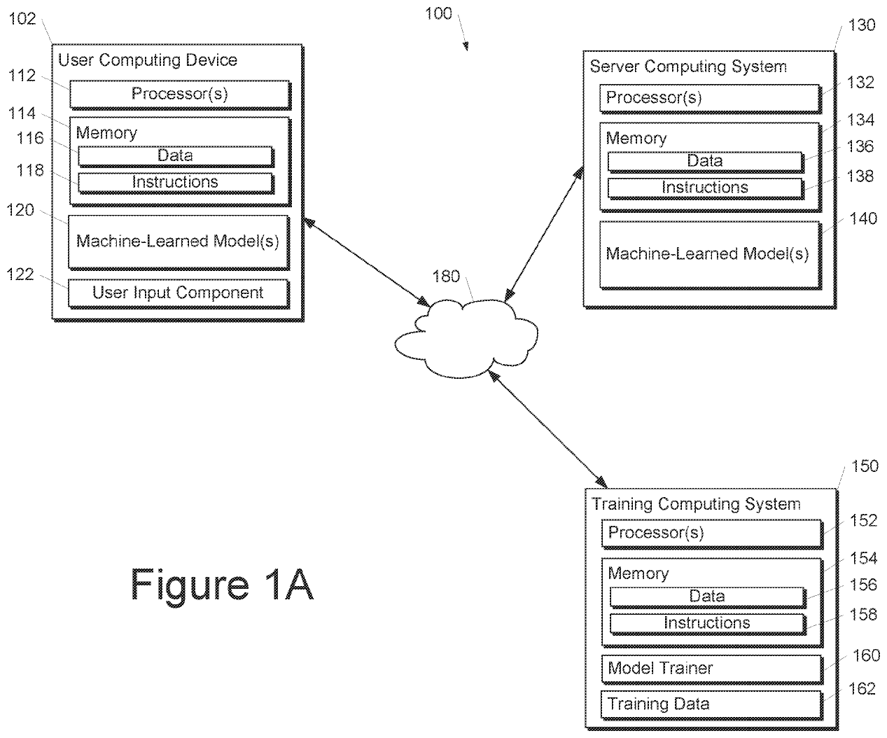

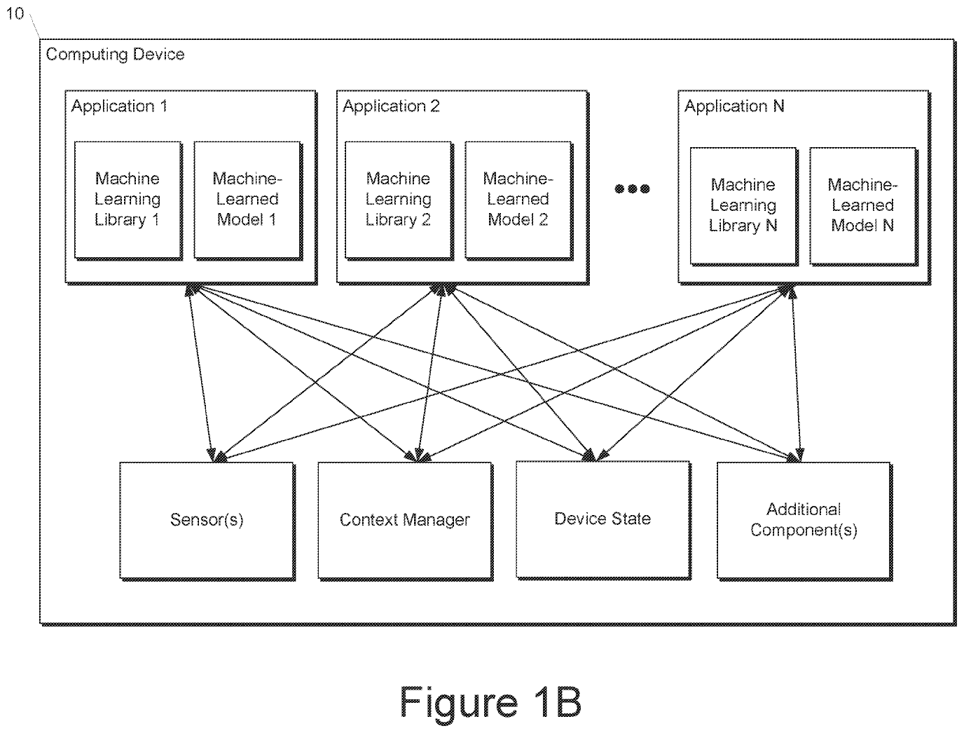

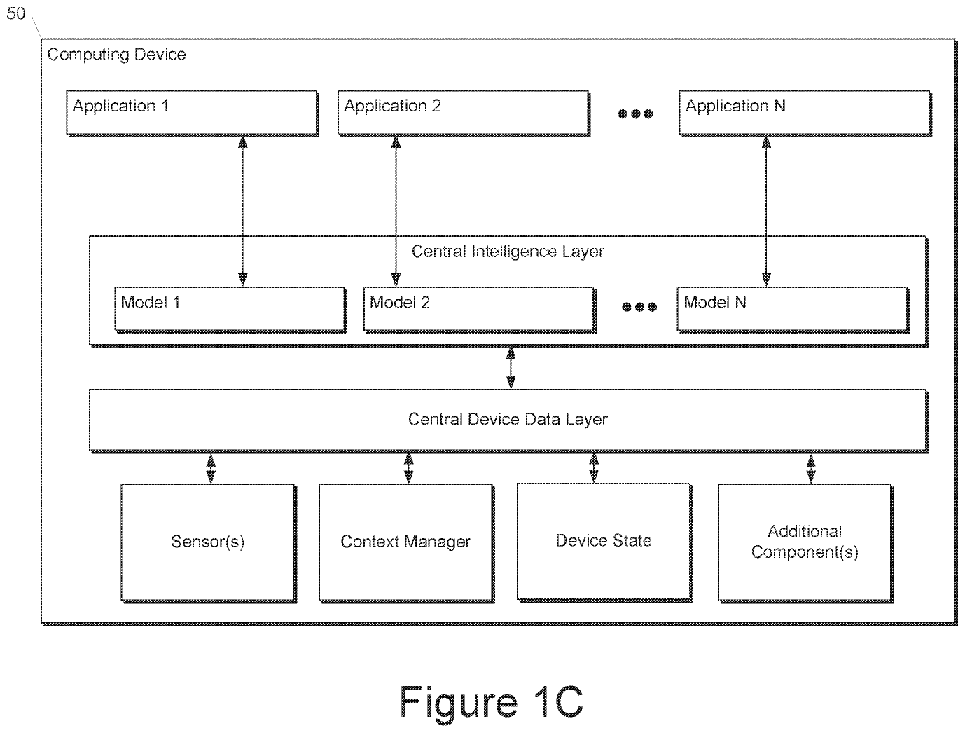

FIG. 1A depicts a block diagram of an example computing system 100 that performs task-specific prompt recycling according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). For example, the models 120 may be or otherwise include a large language model that is configured to perform multiple tasks.

The user computing device 102 can include task-specific prompts that are utilized in accordance with the one or more models 120. The task-specific prompts can be concatenated to inputs to the models 120 to indicate a task for the models 120 to perform of a plurality of tasks the models are configured to perform.

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120 (e.g., to perform parallel language tasks across multiple instances of a large language model).

Additionally, or alternatively, one or more models 140 can be included in or otherwise stored and implemented by the server computing system 130 that communicates with the user computing device 102 according to a client-server relationship. For example, the models 140 can be implemented by the server computing system 140 as a portion of a web service (e.g., a language processing service). Thus, one or more models 120 can be stored and implemented at the user computing device 102 and/or one or more models 140 can be stored and implemented at the server computing system 130. For example, the models 140 may be or otherwise include a large language model that is configured to perform multiple tasks.

The server computing device 130 can include task-specific prompts that are utilized in accordance with the one or more models 140. The task-specific prompts can be concatenated to inputs to the models 140 to indicate a task for the models 140 to perform of a plurality of tasks the models are configured to perform.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. The training data 162 can include, for example, data sufficient to train or otherwise update a model such as a large language model.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

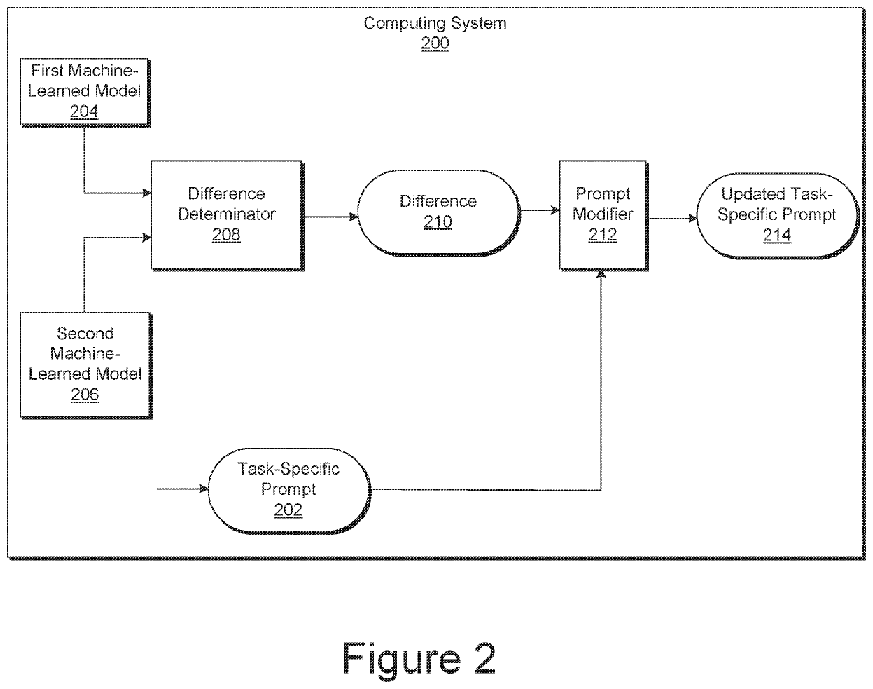

FIG. 2 depicts a block diagram of an example computing system 200 for recycling of task-specific prompts according to example implementations of the present disclosure. Specifically, the computing system 200 (e.g., server computing system 130 of FIG. 1, the user computing device 102 of FIG. 1, etc.) can obtain a task-specific prompt 202 for a first machine-learned model 204. The task-specific prompt 202 is indicative of a task of a plurality of tasks the first machine-learned model 204 is configured to perform. The computing system 200 can obtain the machine-learned model 204 and a second machine-learned model 206 that is different than the first machine-learned model 204. In some implementations, the first machine-learned model 204 may be a base version of a machine-learned model (e.g., a large language model, etc.), and the second machine-learned model 206 may be an updated version of the same model.

The computing system 200 can determine a difference 210 between the first machine-learned model 204 and the second machine-learned model 206 using a difference determinator 208. The computing system 200 can modify the task-specific prompt 202 based on the difference 210 to obtain the updated task-specific prompt 214 that corresponds to the second machine-learned model 206 In such fashion, the computing system can recycle a task-specific prompt 202 such that an updated task-specific prompt 214 can be obtained for utilization with the second machine-learned model 206.

### Example Methods

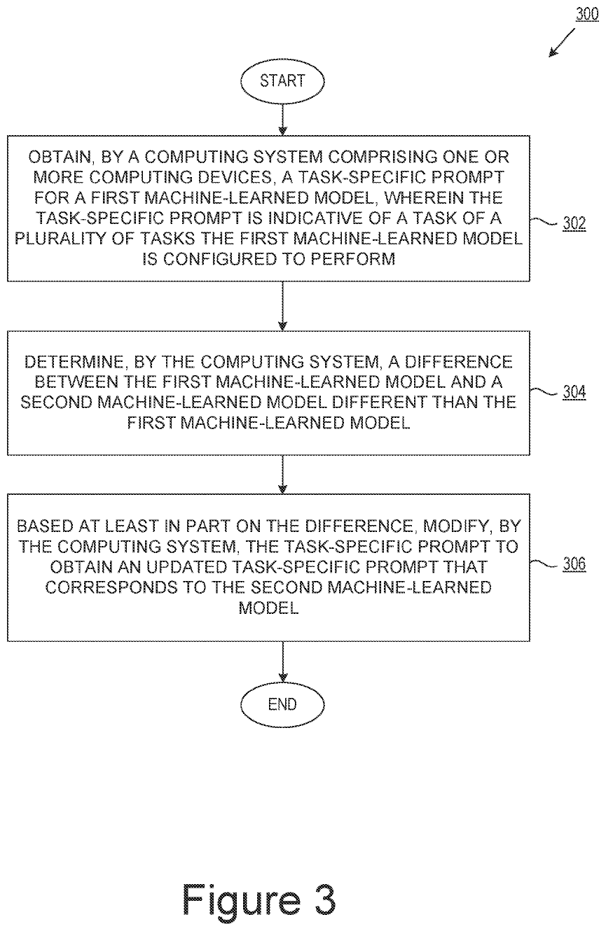

FIG. 3 depicts a flow chart diagram of an example method to perform task-specific prompt recycling according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system obtains a task-specific prompt for a first machine-learned model. The task-specific prompt is indicative of a task of a plurality of tasks the first machine-learned model is configured to perform. In some implementations, the first machine-learned model comprises a trained large language model. In some implementations, the first machine-learned model may be a base version of a machine-learned model (e.g., a large language model, etc.), and the second machine-learned model may be an updated version of the same model.

At 304, the computing system determines a difference between the first machine-learned model and a second machine-learned model different than the first machine-learned model.

In some implementations, determining the difference between the first machine-learned model and the second machine-learned model includes determining a difference between vocabulary embeddings of the first machine-learned model and vocabulary embeddings of the second machine-learned model. In some implementations, determining the difference between the first machine-learned model and the second machine-learned model includes determining a first linear combination of vocabulary embeddings of the first machine-learned model and the task-specific prompt. Modifying the task-specific prompt includes determining, by the computing system, the updated task-specific prompt based at least in part on the linear combination and vocabulary embeddings of the second machine-learned model.

At 306, the computing system, based at least in part on the difference, modifies the task-specific prompt to obtain an updated task-specific prompt that corresponds to the second machine-learned model. In some implementations, modifying the task-specific prompt includes training a machine-learned prompt recycling model based at least in part on the difference, and processing the task-specific prompt with the machine-learned prompt recycling model to obtain the updated task-specific prompt that corresponds to the second machine-learned model.

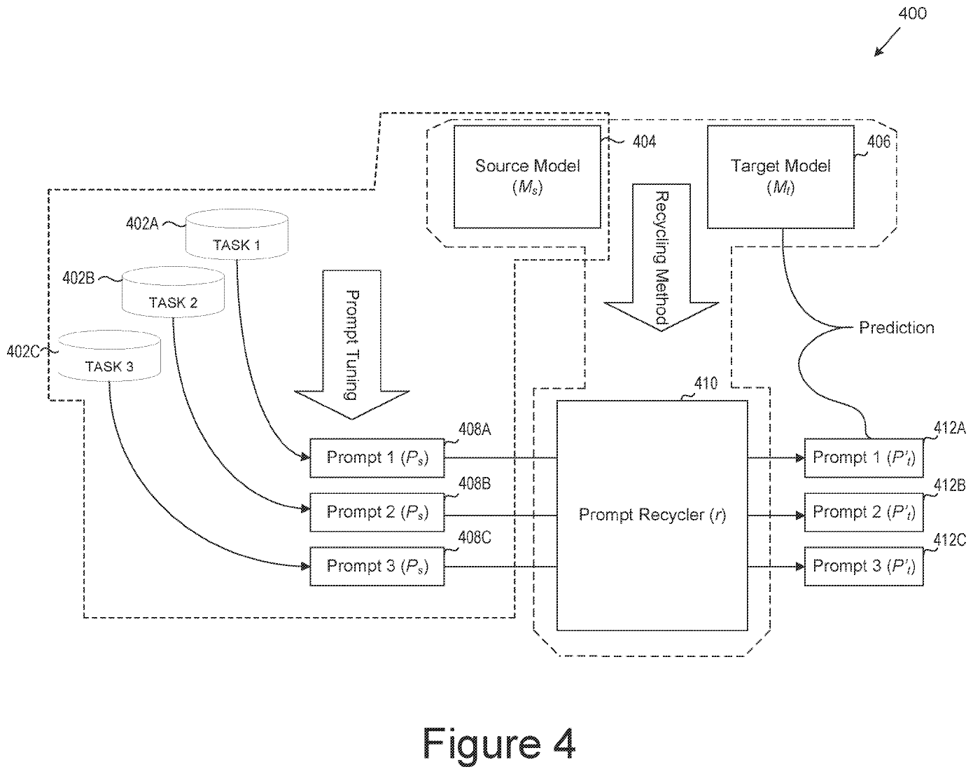

FIG. 4 illustrates an example data flow diagram 400 for recycling of task-specific prompts between a source model and target model according to example embodiments of the present disclosure. In particular, tasks 402A, 402B and 402C (generally, tasks 402) can be tasks for a source model 404. The source model 404 can be a first “version,” or prior state, of large language model (LLM), foundational audio model, foundational computer vision model, or some other manner of machine-learned model that can perform multiple tasks. The target model 406 can be the result of training iteration(s) being applied to the source model 404.

For example, assume that the source model 404 is an LLM trained on a corpus of textual training data created prior to January 2020. If the source model is trained over additional training iterations with textual training data created between January 2020 and December 2020, the resulting model can be the target model 406.

The tasks 402A, 402B, and 402C can be respectively associated with task-specific prompts 408A, 408B, and 408C (generally, prompts 408). In particular, task-specific prompts 408 can be “soft prompts” that modulate model behavior when concatenated by a model input. For example, the task-specific prompt 408A can be a “soft prompt” that causes the source model 404 to perform the task 402A when processed by the source model 404. Similarly, the task-specific prompt 408B can be a “soft prompt” that causes the source model 404 to perform the task 402B when processed by the source model 404.

As described previously, the task-specific prompts 408 are utilized to modulate model behavior. However, this behavior modulation capacity can be reduced or lost when subsequent training iterations are performed for the model. To remedy this problem, a prompt recycler 410 can be utilized to respectively convert the task-specific prompts 408 to updated task specific prompts 412A, 412B, and 412C (generally, updated task-specific prompts 412). The updated task-specific prompts 412 can be prompts that modulate behavior of the target model 406 in the same manner as the task-specific prompts 408 modulate the behavior of the source model 404.

In some implementations, the task-specific prompts 408 can be modified to obtain the updated task-specific prompts 412 in the following manner. First, the task-specific prompts 408 can be trained for tasks 402 using the source model 404. A process performed by the prompt recycler 410 can modify the task-specific prompts 408 to obtain the updated task-specific prompts 412.

In some implementations, the process performed by the prompt recycler 410 can be a “vocab to vocab transformation” process. To perform this process, the prompt recycler 410 can learn a mapping between vocabulary embeddings of the source model 404 and the target model 406, and the mapping can be applied to the task-specific prompts 408 to obtain the updated task-specific prompts 412. For example, let Vₛ represent the vocabulary embeddings (e.g., column vectors, etc.) of the source model Mₛ 404, and let Vₜ represent the vocabulary embeddings of the source model Mₜ 406. The prompt recycler 410 can find a function (i.e., process, etc.) ƒ such that

$$f ( {V}_{s} ) = {V}_{t}$$

Once determined, the updated task-specific prompts 412 can be estimated such that:

$${P}_{t}^{′} = f ( {P}_{s} )$$

In some implementations, function ƒ can be parameterized with a machine-learned model, such as a small neural network. For example, the function ƒ may be parameterized by mapping a source embedding of size Eₛ to a target embedding of size Eₜ with ReLU activations.

Additionally, or alternatively, in some implementations, the function ƒ can be parameterized as a single projection, and the least squares method can be utilized to solve for a matrix Y such that YVₛ=Vₜ. In this manner, P′ₜ=YPₛ can be estimated.

Alternatively, in some implementations, the process performed by the prompt recycler 410 can be a “linear combination” process. The linear combination process can represent each of the task-specific prompts 408 as a linear combination of its vocabulary embedding VₛX=Pₛ. After solving for X, the same linear combination can be utilized on target embedding vectors for corresponding tokens to generate the updated task-specific prompts (i.e., an estimated target prompt) of P′ₜ=VₜX.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Appendix A, which forms a part of the present disclosure and specification, describes various example features of the disclosed technology. Any (or any combination of) these features may be included in the systems, methods, and other embodiments of the present disclosure. However, the present disclosure is not limited to the embodiments described in Appendix A.

1. A computer-implemented method for recycling of task-specific prompts for machine-learned models, the method comprising:
obtaining, by a computing system comprising one or more computing devices, a task-specific prompt for a machine-learned model, wherein the task-specific prompt is indicative of a task of a plurality of tasks the machine-learned model is configured to perform;
determining, by the computing system, a difference between a base version of the machine-learned model and an updated version of the machine-learned model different than the base version of the machine-learned model; and
based at least in part on the difference, modifying, by the computing system, the task-specific prompt to obtain an updated task-specific prompt that corresponds to the updated version of the machine-learned model.

2. The computer-implemented method of claim 1, wherein the machine-learned model comprises a trained large language model.

3. The computer-implemented method of claim 1, wherein determining the difference between the base version of the machine-learned model and the updated version of the machine-learned model comprises:
determining, by the computing system, a difference between vocabulary embeddings of the base version of the machine-learned model and vocabulary embeddings of the updated version of the machine-learned model.

4. The computer-implemented method of claim 3, wherein:
determining the difference between the base version of the machine-learned model and the updated version of the machine-learned model comprises determining, by the computing system, a first linear combination of vocabulary embeddings of the base version of the machine-learned model and the task-specific prompt; and
wherein modifying the task-specific prompt comprises determining, by the computing system, the updated task-specific prompt based at least in part on the first linear combination and vocabulary embeddings of the updated version of the machine-learned model.

5. The computer-implemented method of claim 1, wherein modifying the task-specific prompt comprises:
processing, by the computing system, the task-specific prompt with a machine-learned prompt recycling model to obtain the updated task-specific prompt that corresponds to the updated version of the machine-learned model.

6. The computer-implemented method of claim 5, wherein the method further comprises training, by the computing system, the machine-learned prompt recycling model based on a loss function that evaluates a difference between the updated task-specific prompt and a ground-truth task-specific prompt.

7. The computer-implemented method of claim 5, wherein processing the task-specific prompt with the machine-learned prompt recycling model to obtain the updated task-specific prompt comprises:
generating, by the computing system, a learned transformation matrix with the machine-learned prompt recycling model based on differences between the base version of the machine-learned model and the updated version of the machine-learned model; and
applying, by the computing system, the learned transformation matrix to the task-specific prompt to obtain the updated task-specific prompt.

8. The computer-implemented method of claim 5, wherein, prior to processing the task-specific prompt with a machine-learned prompt recycling model, the method comprises:
identifying, by the computing system, a first plurality of vocabulary embeddings of the base version of the machine-learned model and a second plurality of vocabulary embeddings of the updated version of the machine-learned model;
determining, by the computing system, that a relevance of a first subset of the first plurality of vocabulary embeddings and a relevance of a second subset of the second plurality of vocabulary embeddings are less than a threshold relevance;
respectively removing, by the computing system, the first subset from the first plurality of vocabulary embeddings and the second subset from the second plurality of vocabulary embeddings; and
training, by the computing system, the machine-learned prompt recycling model based on differences between the first plurality of vocabulary embeddings and the second plurality of vocabulary embeddings.

9. A computing system for recycling of task-specific prompts for machine-learned models, comprising:
one or more processors; and
one or more non-transitory computer-readable media that store instructions that, when executed by the one or more processors, cause the computing system to perform operations, the operations comprising:
obtaining a task-specific prompt for a machine-learned model, wherein the task-specific prompt is indicative of a task of a plurality of tasks the machine-learned model is configured to perform;
determining a difference between a base version of the machine-learned model and an updated version of the machine-learned model different than the base version of the machine-learned model; and
based at least in part on the difference, modifying the task-specific prompt to obtain an updated task-specific prompt that corresponds to the updated version of the machine-learned model.

10. The computing system of claim 9, wherein the machine-learned model comprises a trained large language model.

11. The computing system of claim 9, wherein determining the difference between the base version of the machine-learned model and the updated version of the machine-learned model comprises:
determining a difference between vocabulary embeddings of the base version of the machine-learned model and vocabulary embeddings of the updated version of the machine-learned model.

12. The computing system of claim 10, wherein:
determining the difference between the base version of the machine-learned model and the updated version of the machine-learned model comprises determining a first linear combination of vocabulary embeddings of the base version of the machine-learned model and the task-specific prompt; and
wherein modifying the task-specific prompt comprises determining the updated task-specific prompt based at least in part on the first linear combination and vocabulary embeddings of the updated version of the machine-learned model.

13. The computing system of claim 9, wherein modifying the task-specific prompt comprises:
processing the task-specific prompt with a machine-learned prompt recycling model to obtain the updated task-specific prompt that corresponds to the updated version of the machine-learned model.

14. The computing system of claim 13, wherein the operations further comprise training the machine-learned prompt recycling model based on a loss function that evaluates a difference between the updated task-specific prompt and a ground-truth task-specific prompt.

15. The computing system of claim 13, wherein processing the task-specific prompt with the machine-learned prompt recycling model to obtain the updated task-specific prompt comprises:
generating a learned transformation matrix with the machine-learned prompt recycling model based on differences between the base version of the machine-learned model and the updated version of the machine-learned model; and
applying the learned transformation matrix to the task-specific prompt to obtain the updated task-specific prompt.

16. The computing system of claim 13, wherein, prior to processing the task-specific prompt with a machine-learned prompt recycling model, the operations comprise:
identifying a first plurality of vocabulary embeddings of the base version of the machine-learned model and a second plurality of vocabulary embeddings of the updated version of the machine-learned model.

17. One or more non-transitory computer-readable media that store instructions that, when executed by one or more processors, cause the one or more processors to perform operations, the operations comprising:
obtaining a task-specific prompt for a first machine-learned model, wherein the task-specific prompt is indicative of a task of a plurality of tasks the first machine-learned model is configured to perform;
determining a difference between the first machine-learned model and a second machine-learned model different than the first machine-learned model; and
based at least in part on the difference, modifying the task-specific prompt to obtain an updated task-specific prompt that corresponds to the second machine-learned model.

18. The one or more non-transitory computer-readable media of claim 17, wherein the first machine-learned model comprises a trained large language model, and the second machine-learned model comprises a trained language model different than the first machine-learned model.

19. The one or more non-transitory computer-readable media of claim 17, wherein determining the difference between the first machine-learned model and the second machine-learned model comprises:
determining a difference between vocabulary embeddings of the first machine-learned model and vocabulary embeddings of the second machine-learned model.

20. The one or more non-transitory computer-readable media of claim 18, wherein:
determining the difference between the first machine-learned model and the second machine-learned model comprises determining a first linear combination of vocabulary embeddings of the first machine-learned model and the task-specific prompt; and
wherein modifying the task-specific prompt comprises determining the updated task-specific prompt based at least in part on the first linear combination and vocabulary embeddings of the second machine-learned model.
